(19) United States
(12) Patent Application Publication
(10) Pub. No.: US 2006/0221978 A1
(43) Pub. Date: Oct. 5, 2006

(54) Backlogged queue manager

(76) Inventor: Muthaiah Venkatachalam, Hillsboro, OR (US)

Correspondence Address: KACVINSKY LLC, 4500 BROOKTREE ROAD, SUITE 102, WEXFORD, PA, 15090, US

(21) Appl. No.: 11/096,393

(22) Filed: Mar. 31, 2005

(51) Int. Cl. H04L 12/56

(52) U.S. Cl. 370/395.41; 370/412

(57) ABSTRACT

A system, apparatus, method and article to manage backlogged queues are described. The apparatus may include a backlogged queue manager to manage one or more queues. The backlogged queue manager may include a backlogged queue list to store a list of one or more active queues, a scheduler block to dequeue a queue identification corresponding to an active queue, and a queue manager block to dequeue one or more packets from said active queue. Other embodiments are described and claimed.

### BACKGROUND

In high-speed networking systems, packets received by a network device are often enqueued for outgoing transmission. To efficiently allocate network resources, the network device may implement a scheduling policy for determining when packets are transmitted. Various implementations of round robin (RR) scheduling, such as weighted round robin (WRR) scheduling and deficit round robin (DRR) scheduling may be employed to schedule enqueued packets. Implementations of WRR and DRR scheduling may be fairly complex and consume significant processing cycles per packet to achieve desired line rates, such as Optical Carrier (OC) rates and Gigabyte Ethernet (GbE) rates (e.g., OC-48/4 GbE, OC-192/10GbE). In addition, implementations of WRR and DRR scheduling typically are not scaleable with respect to the number of ports and/or queues of a network device.

### BRIEF DESCRIPTION OF THE DRAWINGS

FIG. 1 illustrates one embodiment of a system.

FIG. 2 illustrates one embodiment of a backlogged queue manager.

FIG. 3 illustrates one embodiment of a processing apparatus.

FIG. 4 illustrates one embodiment of a first logic diagram.

FIG. 5 illustrates one embodiment of a second logic diagram.

FIG. 6 illustrates one embodiment of a third logic diagram.

### DETAILED DESCRIPTION

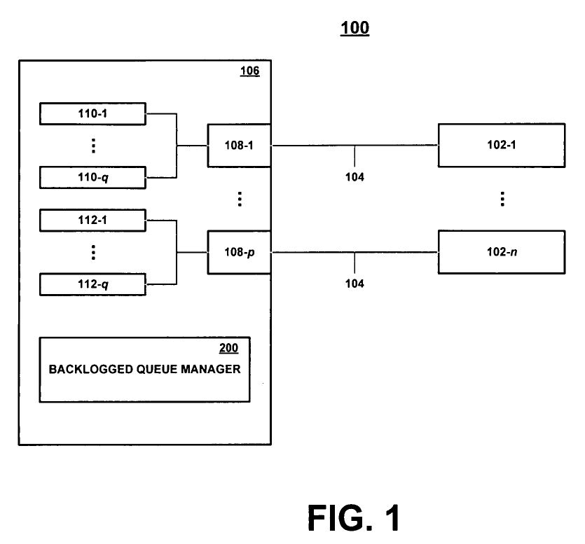

FIG. 1 illustrates a block diagram of a system 100. In one embodiment, for example, the system 100 may comprise a communication system having multiple nodes. A node may comprise any physical or logical entity for communicating information in the system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, a node may comprise, or be implemented as, a computer system, a computer sub-system, a computer, a workstation, a terminal, a server, a personal computer (PC), a laptop, an ultra-laptop, a handheld computer, a personal digital assistant (PDA), a set top box (STB), a telephone, a cellular telephone, a handset, an interface, an input/output (I/O) device (e.g., keyboard, mouse, display, printer), a router, a hub, a gateway, a bridge, a switch, a microprocessor, an integrated circuit, a programmable logic device (PLD), a digital signal processor (DSP), a processor, a circuit, a logic gate, a register, a microprocessor, an integrated circuit, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

The nodes of the system 100 may comprise or form part of a network, such as a Local Area Network (LAN), a Metropolitan Area Network (MAN), a Wide Area Network (WAN), a Wireless LAN (WLAN), the Internet, the World Wide Web, a telephony network (e.g., analog, digital, wired, wireless, PSTN, ISDN, or xDSL), a radio network, a television network, a cable network, a satellite network, and/or any other wired or wireless communications network configured to carry data. The network may include one or more elements, such as, for example, intermediate nodes, proxy servers, firewalls, routers, switches, adapters, sockets, and wired or wireless data pathways, configured to direct and/or deliver data to other networks. The embodiments are not limited in this context.

The nodes of the system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The embodiments are not limited in this context.

In various embodiments, the nodes in the system 100 may communicate information in the form of packets. A packet in this context may refer to a set of information of a limited length typically represented in terms of bits and/or bytes. An example of a packet length might be 1000 bytes. Packets may be communicated according to one or more protocols such as, for example, Transmission Control Protocol (TCP), Internet Protocol (IP), TCP/IP, X.25, Hypertext Transfer Protocol (HTTP), User Datagram Protocol (UDP). It can be appreciated that the described embodiments are applicable to any type of communication content or format, such as packets, frames, cells. The embodiments are not limited in this context.

As shown in FIG. 1, the system 100 may comprise nodes 102-1-n, where n represents any positive integer. The nodes 102-1-n generally may include various sources and/or destinations of information (e.g., media information, control information, image information, video information, audio information, or audio/video information). In various embodiments, nodes 102-1-n may originate from a number of different devices or networks. The embodiments are not limited in this context.

In various implementations, the nodes 102-1-n may send and/or receive information through communications media 104. Communications media 104 generally may comprise any medium capable of carrying information. For example, communication media may comprise wired communication media, wireless communication media, or a combination of both, as desired for a given implementation. The term “connected” and variations thereof, in this context, may refer to physical connections and/or logical connections. The embodiments are not limited in this context.

As shown in FIG. 1, the network 100 may comprise a processing node 106. The processing node 106 may be arranged to perform one or more processing operations. Processing operations may generally refer to one or more operations, such as generating, managing, communicating, sending, receiving, storing forwarding, accessing, reading, writing, manipulating, encoding, decoding, compressing, decompressing, encrypting, filtering, streaming or other processing of information. The embodiments are not limited in this context.

In various implementations, the processing node 106 may be arranged to receive communications from, transmit communications to, and/or manage communications among nodes in the system 100, such as nodes 102-1-n. The processing node 106 may perform ingress and egress processing operations such as receiving, classifying, metering, policing, buffering, scheduling, analyzing, segmenting, enqueuing, traffic shaping, dequeuing, and transmitting. The embodiments are not limited in this context.

As shown in FIG. 1, the processing node 106 may comprise one or more ports, such as ports 108-1-p, where p represents any positive integer. The ports 108-1-p generally may comprise any physical or logical interface of the processing node 106. The ports 108-1-p may include one or more transmit ports, receive ports, and control ports for communicating data in a unidirectional or bidirectional manner between elements in the system 100. The embodiments are not limited in this context.

In one embodiment, for example, the ports 108-1-p may be implemented using one or more line cards. For example, if processing node 106 is implemented as a network switch, the line cards may be coupled to a switch fabric (not shown). The line cards may be used to process data on a network line. Each line card may operate as an interface between a network and the switch fabric. The line cards may convert the data set from the format used by the network to a format for processing. The line cards may also perform various processing on the data set. After processing, the line card may convert the data set into a transmission format for transmission across the switch fabric. The line card also allows a data set to be transmitted from the switch fabric to the network. The line card receives a data set from the switch fabric, processes the data set, and then converts the data set into the network format. The network format can be, for example, an asynchronous transfer mode (ATM) or a different format. The embodiments are not limited in this context.

In various embodiments, the ports 108-1-p may comprise one or more data paths. Each data path may include information signals (e.g., data signals, a clock signal, a control signal, a parity signal, a status signal) and may be configured to use various signaling (e.g., low voltage differential signaling) and sampling techniques (e.g., both edges of clock). The embodiments are not limited in this context.

In various embodiments, each of the ports 108-1-p may be associated with one or more queues, such as queues 110-1-q, 112-1-q, where q represents any positive integer. In various implementations, a particular port, such as port 108-1, may be associated with a particular set of queues, such as queues 110-1-q. Although illustrated as having an equal number of associated queues, in various implementations, the ports 108-1-p may have unequal numbers of associated queues.

In various implementations, a queue may employ a first-in-first-out (FIFO) policy in which a queued packet may be sent only after all previously queued packets have been dequeued. A queue may be associated with a specific flow or class of packets, such as a group of packets having common header data or a common class of service. For example, a packet may be assigned to a particular flow based on its header data and then stored in a queue that corresponds to the flow. The embodiments are not limited in this context.

A queue generally may comprise any type of data structure (e.g., array, file, table, record) capable of storing data prior to transmission. In various embodiments, a queue may be implemented in hardware such as within a static random-access memory (SRAM) array. The SRAM array may comprise machine-readable storage devices and controllers, which are accessible by a processor and which are capable of storing a combination of computer program instructions and data. In various implementations, a controller may perform functions such as atomic read-modify-write operations (e.g., increment, decrement, add, subtract, bit-set, bit-clear, and swap), linked-list queue operations, and ring (e.g., circular buffer) operations. The embodiments are not limited in this context.

In other embodiments, a queue may comprise various types of storage media capable of storing packets and/or pointers to the storage locations of packets. Examples of storage media include read-only memory (ROM), random-access memory (RAM), dynamic RAM (DRAM), Double-Data-Rate DRAM (DDRAM), synchronous DRAM (SDRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic disk (e.g., floppy disk and hard drive), optical disk (e.g., CD-ROM), magnetic or optical cards, or any other type of media suitable for storing information. The embodiments are not limited in this context.

In various embodiments, the system 100 may comprise a backlogged queue manager 200 arranged to manage one or more queues. As shown in FIG. 1, for example, the processing node 106 may comprise a backlogged queue manager 200 arranged to manage queues 110-1-q, 112-1-q. The backlogged queue manager 200 may comprise or be implemented as hardware, software, or any combination thereof, as desired for a given set of design parameters or performance constraints.

In various implementations, the backlogged queue manager 200 may be arranged to monitor the status of one or more queues, such as queues 110-1-q, 112-1-q. For example, when a packet is enqueued into an empty queue, the backlogged queue manager 200 may detect a change in status from empty to active. Also, when the last packet from a queue is transmitted, the backlogged queue manager may detect a change in status from active to empty.

In various implementations, the backlogged queue manager 200 may be arranged to maintain a list of currently active queues. For example, the backlogged queue manager 200 may store a queue identification (QID) associated with an active queue in a backlogged queue list. The backlogged queue manager 200 may add a QID when a queue experiences a transition from empty to active and remove the QID when the queue experiences a transition from active to empty. The backlogged queue manager 200 also may be arranged to maintain a list of queue properties associated with the active queues.

In various implementations, the backlogged queue manager 200 may be arranged to schedule one or more packets from active queues according to a scheduling policy. For example, the backlogged queue manager 200 may implement one or more of RR scheduling, WRR scheduling and DRR scheduling of packets from active queues.

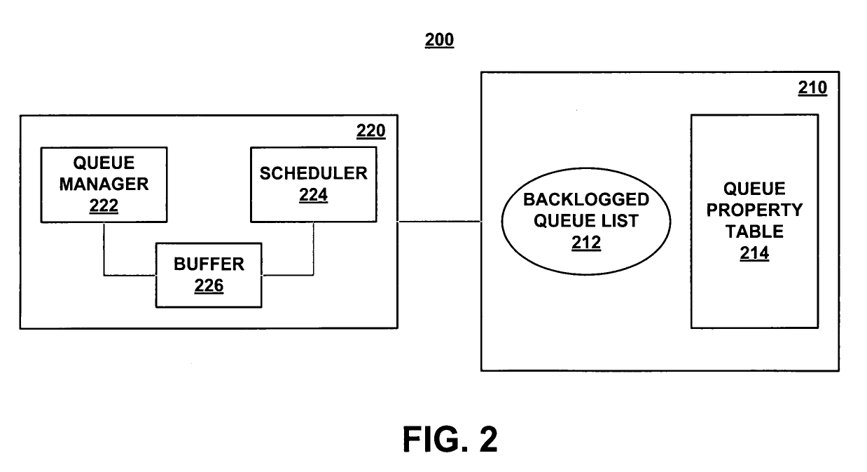

FIG. 2 illustrates one embodiment of a backlogged queue manager 200. It is to be understood that the illustrated backlogged queue manager 200 is an exemplary embodiment and may include additional components, which have been omitted for clarity and ease of understanding.

In various embodiments, the backlogged queue manager 200 may comprise memory 210 and one or more processing engines, such as processing engine 220. In one embodiment, the memory 210 may comprise SRAM. The embodiments are not limited in this context. For instance, the memory 204 may comprise any type or combination of storage media including ROM, RAM, SRAM, DRAM, DDRAM, SDRAM, PROM, EPROM, EEPROM, flash memory, polymer memory, SONOS memory, disk memory, or any other type of media suitable for storing information.

In various embodiments, the processing engine 220 may comprise a processing system arranged to execute a logic flow (e.g., micro-blocks running on a thread of a micro-engine). The processing engine 220 may comprise, for example, an arithmetic and logic unit (ALU), a controller, and a number of registers (e.g., general purpose, SRAM transfer, DRAM transfer, next-neighbor). In various implementations, the processing engine may provide for multiple threads of execution (e.g., four, eight). The processing engine may include a local memory (e.g., SRAM, ROM, EPROM, flash memory) that may be used to store instructions for execution. The embodiments are not limited in this context.

As shown, the backlogged queue manager 200 may comprise a backlogged queue list 212. The backlogged queue list 212 may comprise any type of data storage capable of storing a dynamic list, and the size of the backlogged queue list 212 may be arbitrarily deep. In various implementations, the backlogged queue list 212 may be arranged to store QIDs associated with active queues. The backlogged queue list 212 may be implemented in memory 210. In one embodiment, the memory 210 may comprise SRAM, and the backlogged queue list 212 may comprise a data structure such as linked list in a hardware queue (e.g., QArray based hardware queue). In various implementations, the backlogged queue list may comprise a queue of QIDs. The embodiments are not limited in this context.

In various embodiments, the backlogged queue manager 200 may comprise a queue property table 214. As shown in FIG. 2, the queue property table 214 may be implemented in memory 210 (e.g., SRAM). The queue property table 214 may be arranged to store various properties associated with active queues. In various implementations, the queue property table 214 may be indexed by QID and contain one or more properties of a queue according to one or more scheduling policies.

One example of a scheduling policy is round robin (RR) scheduling in which all queues are treated equally and serviced one-by-one in a sequential manner. For example, RR scheduling may involve scheduling an equal number of packets from each active queue based on the order of QIDs in the backlogged queue list 212. For RR scheduling, the backlogged queue manager 200 may manage queues equally. Accordingly, in some implementations, the queue property table 214 may store identical weighted values for each queue. In other implementations, the queue property table 214 may contain no entries for RR scheduling.

Another example of a scheduling policy is weighted round robin (WRR) scheduling in which queues are serviced one-by-one in a sequential manner and packets are scheduled according to a weight value. For example, WRR scheduling may involve scheduling packets from active queues based on the order of QIDs in the backlogged queue list 212, where the number of packets that can be scheduled from a particular queue is based on a weight value for the queue. For WRR scheduling, the backlogged queue manager 200 may manage queues according to weight value. Accordingly, the queue property table 214 may store a weight value for each queue.

Another example of a scheduling policy is deficit round robin (DRR) scheduling in which queues are serviced one-by-one in a sequential manner and packets are scheduled according to allocated bandwidth (e.g., bytes). For example, DRR scheduling may involve scheduling packets from active queues based on the order of QIDs in the backlogged queue list 212, where the number of packets that can be scheduled from a particular queue is based on allocated and available bandwidth.

In various embodiments, allocated bandwidth may be expressed as a quantum value (e.g., bytes) allocated to a queue per scheduling round. The quantum value may be the same for all queues or may be different for the various queues. In various implementations, the quantum value may be set to a value that exceeds a maximum packet size.

In various embodiments, available bandwidth may be expressed as a credit counter value (e.g., bytes) representing an amount available to a queue during a scheduling round. As packets are scheduled, the credit counter decreases. In general, a packet larger than the credit counter value may not be scheduled during a give scheduling round, and the number of packets scheduled for a queue during any given round cannot exceed the credit counter value for that queue. In various implementations, the credit counter value may be reset to zero when a queue becomes empty. In other implementations, the credit counter value may retain unused credit for a future round.

For DRR scheduling, the backlogged queue manager 200 may manage queues according to allocated and consumed bandwidth. Accordingly, the queue property table 214 may store a quantum value and a credit counter for each queue. The embodiments are not limited in this context.

As shown in FIG. 2, the backlogged queue manager 200 may comprise a queue manager block 222. In various embodiments, the queue manager block 222 may comprise logic flow running on the processing engine 220. The queue manager block 222 may be arranged to enqueue packets into queues and dequeue packets from queues. The queue manager block 222 may monitor the status (e.g., active, empty) of one or more queues and enqueue QIDs for active queues to the backlogged queue list 212. The queue manager block 222 may dequeue one or more packets from an active queue based on the QID and properties (e.g., weight, quantum, and credit counter) of the queue. The embodiments are not limited in this context.

The backlogged queue manager 200 may comprise a scheduler block 224. In various embodiments, the scheduler block 224 may comprise a logic flow running on the processing engine 220. The scheduler block may be arranged to make various scheduling decisions to schedule packets for transmission. As shown in FIG. 2, for example, the scheduler block 224 may communicate with the queue manager block 222 through a buffer 226, such as a ring buffer capable of inter-block communication. In various embodiments, the scheduler block 224 may be arranged to dequeue a QID from the backlogged queue list 212 and retrieve queue properties associated with the dequeued QID. The scheduler block 224 may pass the QID and/or queue properties to the queue manager block 222 by writing to the buffer 226, for example. If data remains in the queue, the scheduler block 224 may put back the QID at the end of the backlogged queue list 212. The embodiments are not limited in this context.

In various implementations, the scheduler block 224 may perform one more operations on the queue properties based on a particular scheduling policy. For example, when implementing DRR scheduling, the scheduler block 224 may increment the credit count value by the quantum value during a round to ensure that at least one packet may be scheduled from a queue during the round. The embodiments are not limited in this context.

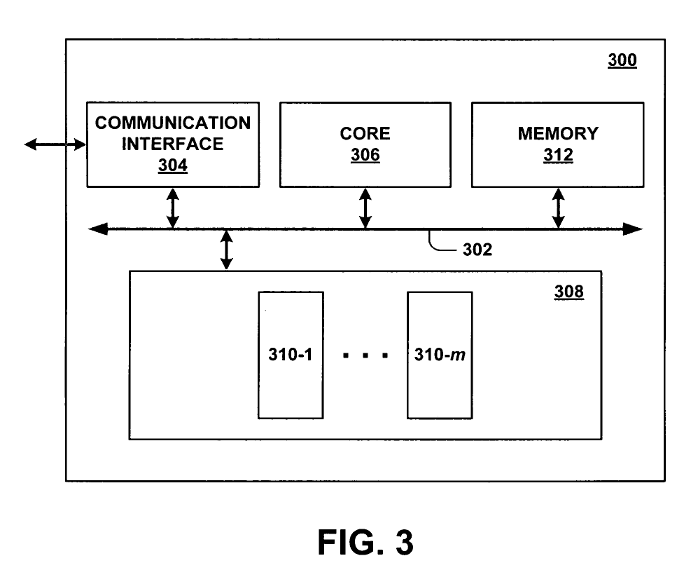

FIG. 3 illustrates one embodiment of a processing apparatus 300. It is to be understood that the illustrated processing apparatus 300 is an exemplary embodiment and may include additional components, which have been omitted for clarity and ease of understanding.

The processing apparatus 300 may comprise a bus 302 to which various functional units may be coupled. In various implementations, the bus 302 may comprise a collection of one or more on-chip buses that interconnect the various functional units of the processing apparatus 300. Although the bus 302 is depicted as a single bus for ease of understanding, it may be appreciated that the bus 302 may comprise any bus architecture and may include any number and combination of buses. The embodiments are not limited in this context.

The processing device 300 may comprise a communication interface 304 coupled with the bus 302. The communication interface 304 may comprises any suitable hardware, software, or combination of hardware and software that is capable of coupling the processing apparatus to one or more networks and/or network devices. In various embodiments, the communication interface 304 may comprise one or more interfaces such as, for example, transmit interfaces, receive interfaces, a Media and Switch Fabric (MSF) Interface, a System Packet Interface (SPI), a Common Switch Interface (CSI), a Peripheral Component Interface (PCI), a Small Computer System Interface (SCSI), an Internet Exchange (IE) interface, Fabric Interface Chip (FIC) interface, as well as other interfaces. In various implementations, the communication interface 304 may be arranged to connect the processing apparatus 300 to one or more physical layer devices and/or a switch fabric. The embodiments are not limited in this context.

The processing apparatus 300 may comprise a core 306. The core 306 may comprise a general purpose processing system having access to various functional units and resources. In various embodiments, the processing system may comprise a general purpose processor, such as a general purpose processor made by Intel® Corporation, Santa Clara, Calif., for example. In other embodiments, the processing system may comprise a dedicated processor, such as a controller, micro-controller, embedded processor, a digital signal processor (DSP), a field programmable gate array (FPGA), a programmable logic device (PLD), a network processor, an I/O processor, and so forth. In various implementations, the core 306 may be arranged to execute an operating system and control operation of the processing apparatus 300. The core 306 may perform various processing operations such as performing management task, dispensing instructions, and handling exception packets. The embodiments are not limited in this context.

The processing apparatus 300 may comprise a processing engine cluster 308 including a number of processing engines, such as processing engines 310-1-m, where m represents any positive integer. In one embodiment, the processing apparatus may comprise two clusters of eight processing engines. Each of the processing engines 310-1-m may comprise a processing system arranged to execute logic flow (e.g., micro-blocks running on a thread of a micro-engine). A processing engine may comprise, for example, an ALU, a controller, and a number of registers and may provide for multiple threads of execution (e.g., four, eight). A processing engine may include a local memory storing instructions for execution. The embodiments are not limited in this context.

The processing apparatus 300 may comprise a memory 312. In various embodiments, the memory 312 may comprise, or be implemented as, any machine-readable or computer-readable storage media capable of storing data, including both volatile and non-volatile memory. Examples of storage media include ROM, RAM, SRAM, DRAM, DDRAM, SDRAM, PROM, EPROM, EEPROM, flash memory, polymer memory, SONOS memory, disk memory, or any other type of media suitable for storing information. The memory 312 may contain various combinations of machine-readable storage devices through various controllers, which are accessible by a processor and which are capable of storing a combination of computer program instructions and data. The embodiments are not limited in this context.

In various embodiments, the backlogged queue manager 200 of FIG. 2 may be implemented by one or more elements of the processing apparatus 300. For example, the backlogged queue manager 200 may comprise, or be implemented by, one or more of the processing engines 310-1-m and/or memory 312. The embodiments are not limited in this context.

Operations for the embodiments may be further described with reference to the following figures and accompanying examples. Some of the figures may include logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

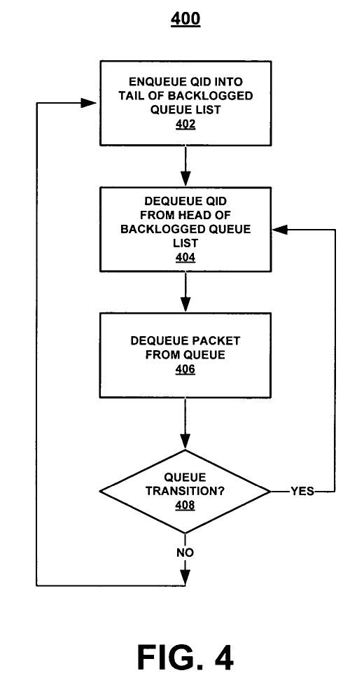

FIG. 4 illustrates a diagram of one embodiment of a logic flow 400 for managing backlogged queues. In various implementations, the logic flow 400 may performed in accordance with a round robin (RR) scheduling policy and executed per minimum packet transmission time.

At block 402, a QID may be enqueued into a backlogged queue list. The QID may be enqueued to the tail of the backlogged queue list. In various embodiments, a backlogged queue manager, such as backlogged queue manager 200, may monitor the status of one or more queues and may maintain a list of currently active queues. In various implementations, a QID may be enqueued when a queue experiences a transition from empty to active (e.g., a packet is enqueued into an empty queue). The QID may be enqueued into a backlogged queue list 212, which may be implemented in SRAM. The embodiments are not limited in this context.

At block 404, a QID may be dequeued from the backlogged queue list. The QID may be dequeued from the head of the backlogged queue list. In various embodiments, a backlogged queue manager, such as backlogged queue manager 200, may dequeue a QID from a backlogged queue list 212. In various implementations, the backlogged queue manager 200 may comprise a scheduler block 224 arranged to dequeue a QID from the backlogged queue list 212. The embodiments are not limited in this context.

At block 406, a packet may be dequeued from a queue. In various embodiments, a backlogged queue manager, such as backlogged queue manager 200, may dequeue a packet from an active queue associated with the QID. In various implementations, the backlogged queue manager 200 may comprise a scheduler block 224 arranged to pass a QID to a queue manager block 222 by writing a QID into a buffer 226. The queue manager block 222 may dequeue a packet from the queue associated with the QID. The embodiments are not limited in this context.

At block 408, a determination is made whether there has been a queue transition. In various embodiments, a backlogged queue manager, such as backlogged queue manager 200, may determine whether a queue transition has occurred by checking whether the queue contains one or more packets. In various implementations, the backlogged queue manager 200 may comprise a queue manager block 222 arranged to monitor the transition status of one or more queues. The embodiments are not limited in this context.

If there has been no transition, a QID may be enqueued into the backlogged queue list, at block 402. The QID may be enqueued to the tail of the backlogged queue list. In various embodiments, if the queue remains active (e.g., contains one or more packets), the backlogged queue manager 200 may enqueue the QID back into the backlogged queue list 212. The embodiments are not limited in this context.

If there has been a queue transition, a QID may be dequeued from the backlogged queue list, at block 402. The QID may be dequeued from the head of the backlogged queue list. In various embodiments, if the queue becomes empty, the backlogged queue manager 200 may dequeue the next QID stored in the backlogged queue list 212. The embodiments are not limited in this context.

It is to be understood that while reference may be made to the backlogged queue manager 200 of FIG. 2, the logic flow 400 may be implemented by various types of hardware, software, and/or combination thereof.

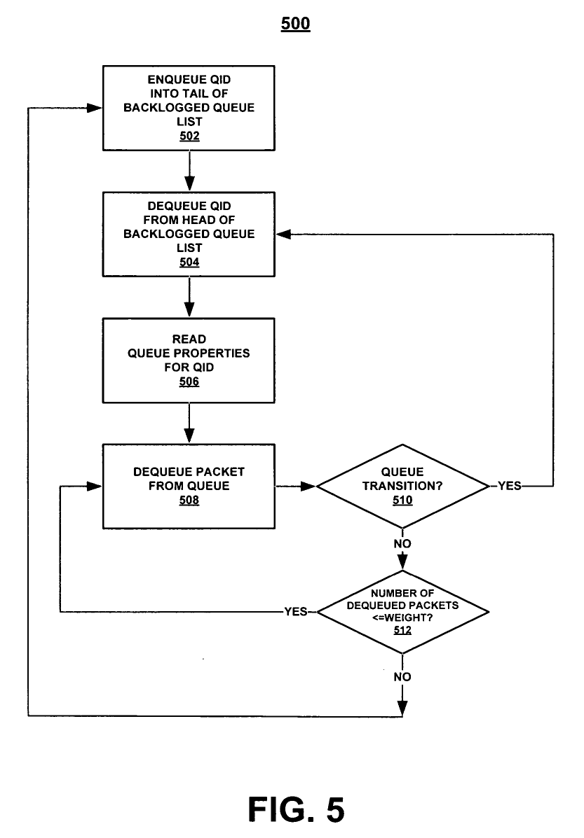

FIG. 5 illustrates a diagram of one embodiment of logic flow 500 for managing backlogged queues. In various implementations, the logic flow 500 may performed in accordance with a weighted round robin scheduling (WRR) policy and executed per minimum packet transmission time.

At block 502, a QID may be enqueued into a backlogged queue list. The QID may be enqueued to the tail of the backlogged queue list. In various embodiments, a backlogged queue manager, such as backlogged queue manager 200, may monitor the status of one or more queues and may maintain a list of currently active queues. In various implementations, a QID may be enqueued when a queue experiences a transition from empty to active (e.g., a packet is enqueued into an empty queue). The QID may be enqueued into a backlogged queue list 212, which may be implemented in SRAM. The embodiments are not limited in this context.

At block 504, a QID may be dequeued from a backlogged queue list. The QID may be dequeued from the head of the backlogged queue list. In various embodiments, a backlogged queue manager, such as backlogged queue manager 200, may dequeue a QID from a backlogged queue list 212. In various implementations, the backlogged queue manager 200 may comprise a scheduler block 224 arranged to dequeue a QID from the backlogged queue list 212. The embodiments are not limited in this context.

At block 506, one or more queue properties for a QID may be read. In various embodiments, a backlogged queue manager, such as backlogged queue manager 200, may read one or more queue properties corresponding to the QID. In various implementations, the backlogged queue manager 200 may comprise a scheduler block 224 arranged to retrieve queue properties corresponding to a dequeued QID from a queue property table 214. The queue properties may comprise a weight value. The embodiments are not limited in this context.

At block 508, a packet may be dequeued from a queue. In various embodiments, a backlogged queue manager, such as backlogged queue manager 200, may dequeue a packet from an active queue associated with the QID. In various implementations, the backlogged queue manager 200 may comprise a scheduler block 224 arranged to pass a QID to a queue manager block 222 by writing a QID into a buffer 226. The scheduler block 224 may issues a number of dequeues for the QID based on the weight value. For example, the scheduler block 224 may write into the buffer 226 one multiple times according to the weight value. The queue manager block 222 may dequeue one or more packets from the queue associated with the QID according to the weight value. The embodiments are not limited in this context.

At block 510, a determination is made whether there has been a queue transition. In various embodiments, a backlogged queue manager, such as backlogged queue manager 200, may determine whether a queue transition has occurred by checking whether the queue contains one or more packets. In various implementations, the backlogged queue manager 200 may comprise a queue manager block 222 arranged to monitor the transition status of one or more queues. The embodiments are not limited in this context.

At block 512, if there has been no transition, a determination may be made as to whether the number of packets issued is less than the weight value associated with the queue. If the weight value has not been met, another packet may be dequeued from the queue at block 508 and another determination made as to whether there has been a queue transition at block 510.

If the weight value has been met and there has been no transition, a QID may be enqueued into the backlogged queue list, at block 502. The QID may be enqueued to the tail of the backlogged queue list. In various embodiments, if the queue remains active (e.g., contains one or more packets) after a weight number of packets has been dequeued, the backlogged queue manager 200 may enqueue the QID back into the backlogged queue list 212. The embodiments are not limited in this context.

If there has been a queue transition, a QID may be dequeued from the backlogged queue list, at block 502. The QID may be dequeued from the head of the backlogged queue list. In various embodiments, if the queue becomes empty, the backlogged queue manager 200 may dequeue the next QID stored in the backlogged queue list 212. The embodiments are not limited in this context.

It is to be understood that while reference may be made to the backlogged queue manager 200 of FIG. 2, the logic flow 500 may be implemented by various types of hardware, software, and/or combination thereof.

One embodiment of an algorithm algorithm/pseudo code for RR and WRR scheduling, executed per minumum packet transmission time, is shown below:

Queue Manager's scheduler related ops:
Upon Enqueue:
When there is an enqueue with transition for a queue,
{

ENQUEUE the QID into the backlogged_queue_SRAM_HW_{—}
queue

}
Upon Dequeue:
When there is a dqueue without transition for a qeueue:
{

ENQUEUE the QID into the backlogged_queue_SRAM_HW_{—}
queue

}
Scheduler:
DEQUEUE QID from backlogged_queue SRAM ring.
Read weight(QID) from the queue_property table in SRAM.

//Weight(QID) = 1 for all queues in RR

Issue dequeue of QID Weight(QID) number of times by doing a PUT into
Deq_scratch_ring each time.

As shown above, a common algorithm/pseudo code may be implemented for RR and WRR scheduling by assigning a weight value of 1 to all queues performing RR scheduling. The embodiments are not limited in this context.

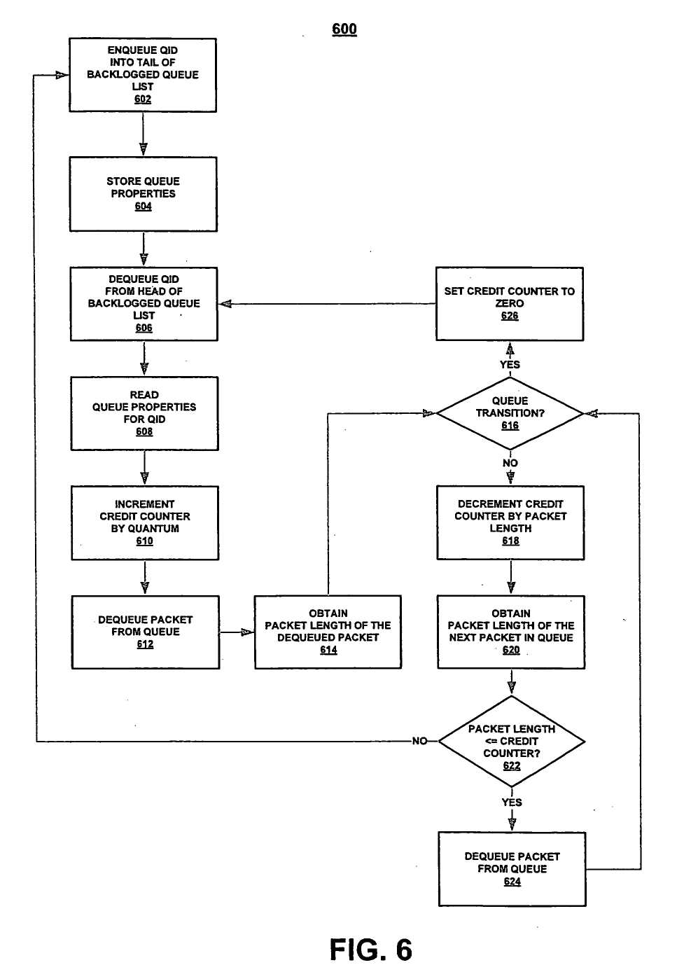

FIG. 6 illustrates a diagram of one embodiment of logic flow 600 for managing backlogged queues. In various implementations, the logic flow 600 may performed in accordance with a deficit round robin scheduling (DRR) policy and executed per minimum packet transmission time.

At block 602, a QID may be enqueued into a backlogged queue list. The QID may be enqueued to the tail of the backlogged queue list. In various embodiments, a backlogged queue manager, such as backlogged queue manager 200, may monitor the status of one or more queues and may maintain a list of currently active queues. In various implementations, a QID may be enqueued when a queue experiences a transition from empty to active (e.g., a packet is enqueued into an empty queue). The QID may be enqueued into a backlogged queue list 212, which may be implemented in SRAM. The embodiments are not limited in this context.

At block 604, one or more queue properties for a QID may be stored. In various embodiments, a backlogged queue manager, such as backlogged queue manager 200, may store one or more queue properties corresponding to the QID. In various implementations, queue properties may be indexed by QID in a queue property table 214. The queue properties may comprise a quantum value and a credit counter value. The quantum value may comprise bandwidth (e.g., bytes) allocated to a queue per scheduling round and may be set to a value that exceeds a maximum packet size. The credit counter value may comprise available bandwidth (e.g., bytes) of a queue during a scheduling round. The embodiments are not limited in this context.

At block 606, a QID may be dequeued from the backlogged queue list. The QID may be dequeued from the head of the backlogged queue list. In various embodiments, a backlogged queue manager, such as backlogged queue manager 200, may dequeue a QID from a backlogged queue list. In various implementations, the backlogged queue manager 200 may comprise a scheduler block 224 arranged to dequeue a QID from a backlogged queue list 212. The embodiments are not limited in this context.

At block 608, one or more queue properties for a QID may be read. In various embodiments, a backlogged queue manager, such as backlogged queue manager 200, may read one or more queue properties corresponding to the QID. In various implementations, the backlogged queue manager 200 may comprise a scheduler block 224 arranged to retrieve queue properties corresponding to a dequeued QID from a queue property table 214. The queue properties may comprise a quantum value and a credit counter value. The embodiments are not limited in this context.

At block 610, a credit counter value may be incremented by a quantum value. In various embodiments, a backlogged queue manager, such as backlogged queue manager 200, may manipulate one or more queue properties corresponding to the QID. In various implementations, the backlogged queue manager 200 may comprise a scheduler block 224 arranged to increment the credit counter value by a quantum amount. When the quantum value exceeds a maximum packet length, incrementing a non-negative credit counter value may ensure that at least one packet may be scheduled during a round. The embodiments are not limited in this context.

At block 612, a packet may be dequeued from a queue. In various embodiments, a backlogged queue manager, such as backlogged queue manager 200, may dequeue a packet from an active queue associated with the QID. In various implementations, the backlogged queue manager 200 may comprise a scheduler block 224 arranged to pass a QID to a queue manager block 222 by writing a QID into a buffer 226. The queue manager block 222 may dequeue one or more packets from the queue associated with the QID according to quantum value (e.g., allocated bandwidth) and the credit counter value (e.g., available bandwidth). The embodiments are not limited in this context.

At block 614, a packet length may be obtained. In various embodiments, a backlogged queue manager, such as backlogged queue manager 200, may obtain the packet length of the dequeued packet. The embodiments are not limited in this context.

At block 616, a determination is made whether there has been a queue transition. In various embodiments, a backlogged queue manager, such as backlogged queue manager 200, may determine whether a queue transition has occurred by checking whether the queue contains one or more packets. In various implementations, the backlogged queue manager 200 may comprise a queue manager block 222 arranged to monitor the transition status of one or more queues. The embodiments are not limited in this context.

If there has been no transition, the credit counter may be decremented by the packet length at block 618. In various embodiments, a backlogged queue manager, such as backlogged queue manager 200, may manipulate one or more queue properties. In various implementations, the backlogged queue manager 200 may comprise a scheduler block 224 arranged to decrement the credit counter by the packet length so that the credit counter represents an amount of available bandwidth.

At block 620, a packet length may be obtained. In various embodiments, a backlogged queue manager, such as backlogged queue manager 200, may obtain the packet length of the next packet in the queue. The embodiments are not limited in this context.

At block 622, a determination may be made as to whether the packet length of the next packet is less than or equal to the credit counter value. If the packet length is less than or equal to the credit counter value, the packet may be dequeued from the queue at block 624 and another determination made as to whether there has been a queue transition at block 616.

If the packet length is greater than the credit counter and there has been no transition, a QID may be enqueued into the backlogged queue list at block 602, and queue properties may be stored at block 604. The QID may be endueued to the tail of the backlogged queue list. In various embodiments, if the queue remains active (e.g., contains one or more packets) after one or more packets are dequeued, the backlogged queue manager 200 may enqueue the QID back into the backlogged queue list 212 and store queue properties into the queue property table 214. The embodiments are not limited in this context.

If there has been a queue transition, the credit counter value may be set to zero at block 626 and a QID may be dequeued from the backlogged queue list, at block 606. The QID may be dequeued from the head of the backlogged queue list. In various embodiments, if the queue becomes empty, the backlogged queue manager 200 may atomically sets the credit counter for the QID to zero and dequeue the next QID stored in the backlogged queue list 212. The embodiments are not limited in this context.

It is to be understood that while reference may be made to the backlogged queue manager 200 of FIG. 2, the logic flow 600 may be implemented by various types of hardware, software, and/or combination thereof.

One embodiment of an algorithm algorithm/pseudo code for RR and WRR scheduling, executed per minimum packet transmission time, is shown below:

Queue Manager's scheduler related ops:
Upon Enqueue:
When there is an enqueue with transition for a queue,
{

ENQUEUE the QID into the backlogged_queue_SRAM_HW_{—}
queue

}
Upon Dequeue:
When there is an dequeue without transition for a queue,
{

ENQUEUE the QID into the backlogged_queue_SRAM_HW_{—}
queue
Credit_counter(QID) −= pktlen. //using SRAM atomics

}
else
if there is a dequeue with transition,
{
set Credit_counter(QID) = 0 //using SRAM atomics
}
Scheduler:
//choosing the queue to dequeue from
DEQUEUE QID from backlogged_queue_SRAM_HW_Queue.
Read Quantum(QID) from the queue_property table in SRAM.
Credit_counter(QID) += Quantum(QID) //using SRAM atomics
Issue dequeue of QID by PUT into Deq_scratch_ring.

In various implementations, the described embodiments provide techniques for RR, WRR, and DRR scheduling that may provide improved performance and scalability. The described embodiments may be implemented on various processing systems such as the Intel® IXP2400 network processor, the Intel® IXP2800 network processor, the Intel® Software Development Kit (SDK), and the Intel® Internet Exchange Architecture (IXA), for example. The described embodiments may be extremely scaleable with respect to number of queues, number of ports, and line rates (e.g., OC line rates, GbE line rates).

In various implementations, the described embodiments may significantly improve scheduling on ingress and egress network processors. For example, RR and WRR scheduling may require less than 20 cycles per packet without flow control, and DRR scheduling may require approximately 25 cycles per packet. The consumption of relatively few cycles per packet makes processing cycles available as headroom for other useful purposes.

In various implementations, the described embodiments may further improve performance by reducing the consumption of resources. For example, it may take less than the processing power of a single micro-engine to achieve OC-48/4 GbE on the Intel® IXP2400 network processor and OC-192/10GbE on the Intel® IXP2800 network processor eliminating the requirement of multiple micro-engines. In various embodiments, the queue state may be stored in external SRAM rather than local memory. Additionally, in some embodiments, no local memory is used by the scheduler, freeing local memory to be used by other micro-blocks running on the same micro-engine.

It is to be understood that the described embodiments of the backlogged queue manager are not limited in application and may be applicable to various devices, systems, and/or operations involving the scheduling of communications. For example, the described embodiments may be implemented in a switch on a high speed backplane fabric in some implementations.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although a system may be illustrated using a particular communications media by way of example, it may be appreciated that the principles and techniques discussed herein may be implemented using any type of communication media and accompanying technology. For example, a system may be implemented as a wired communication system, a wireless communication system, or a combination of both.

When implemented as a wireless system, for example, a system may include one or more wireless nodes arranged to communicate information over one or more types of wireless communication media. An example of a wireless communication media may include portions of a wireless spectrum, such as the radio-frequency (RF) spectrum and so forth. The wireless nodes may include components and interfaces suitable for communicating information signals over the designated wireless spectrum, such as one or more antennas, wireless transmitters/receivers (“transceivers”), amplifiers, filters, control logic, and so forth. As used herein, the term “transceiver” may be used in a very general sense to include a transmitter, a receiver, or a combination of both. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. The embodiments are not limited in this context.

When implemented as a wired system, for example, a system may include one or more nodes arranged to communicate information over one or more wired communications media. Examples of wired communications media may include a wire, cable, metal leads, printed circuit board (PCB), backplane, switch fabric, semiconductor material, twisted-pair wire, co-axial cable, fiber optics, and so forth. The embodiments are not limited in this context.

In various embodiments, communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a backlogged queue manager to manage one or more queues, the backlogged queue manager comprising:
a backlogged queue list to store a list of one or more active queues, each active queue comprising one or more packets;
a scheduler block to dequeue a queue identification corresponding to an active queue; and
a queue manager block to dequeue one or more packets from said active queue.

2. The apparatus of claim 1, wherein said queue manager block is to detect a transition status of one or more queues.

3. The apparatus of claim 2, wherein said queue manager block is to enqueue a queue identification to said backlogged queue list based on the transition status.

4. The apparatus of claim 1, further comprising a queue property table to store one or more properties of a queue.

5. The apparatus of claim 4, wherein said queue property table comprises at least one property of said active queue, and said queue manager is to dequeue one or more packets from said active queue based on said at least one property.

6. The apparatus of claim 1, further comprising one or more processing engines, wherein said scheduler uses no local memory of said one or more processing engines.

7. A system, comprising:
a processing node to process information received from a source node, said processing node to comprise at least one line card and a backlogged queue manager, said backlogged queue manager to manage one or more queues, said backlogged queue manager comprising:
a backlogged queue list to store a list of one or more active queues, each active queue comprising one or more packets;
a scheduler block to dequeue a queue identification corresponding to an active queue; and
a queue manager block to dequeue one or more packets from said active queue.

8. The system of claim 7, wherein said queue manager block is to detect a transition status of one or more queues.

9. The system of claim 8, wherein said queue manager block is to enqueue a queue identification to said backlogged queue list based on the transition status.

10. The system of claim 7, further comprising a queue property table to store one or more properties of a queue.

11. The system of claim 10, wherein said queue property table comprises at least one property of said active queue, and said queue manager is to dequeue one or more packets from said active queue based on said at least one property.

12. A method, comprising:
storing a backlogged queue list of one or more active queues, each active queue comprising one or more packets;
dequeuing a queue identification corresponding to an active queue; and
dequeuing one or more packets from said active queue.

13. The method of claim 12, further comprising detecting a transition status of one or more queues.

14. The method of claim 13, further comprising enqueuing a queue identification to said backlogged queue list based on the transition status.

15. The method of claim 12, further comprising storing one or more properties of a queue.

16. The method of claim 15, further comprising storing at least one property of said active queue and dequeuing one or more packets from said active queue based on said at least one property.

17. The method of claim 12, further comprising scheduling a packet according to a round robin scheduling policy, wherein scheduling requires less than 20 cycles per packet.

18. The method of claim 12, further comprising scheduling a packet according to a weighted round robin scheduling policy, wherein scheduling requires less than 20 cycles per packet.

19. The method of claim 12, further comprising scheduling a packet according to a deficit round robin scheduling policy, wherein scheduling requires approximately 25 cycles per packet.

20. The method of claim 12, further comprising scheduling a packet, wherein scheduling is scaleable with respect to line rates.

21. The method of claim 12, further comprising scheduling a packet, wherein scheduling is scaleable with respect to number of queues.

22. An article comprising a machine-readable storage medium containing instructions that if executed enable a system to:
store a backlogged queue list of one or more active queues, each active queue comprising one or more packets;
dequeue a queue identification corresponding to an active queue; and
dequeue one or more packets from said active queue.

23. The article of claim 22, further comprising instructions that if executed enable the system to detect a transition status of one or more queues.

24. The article of claim 23, further comprising instructions that if executed enable the system to enqueue a queue identification to said backlogged queue list based on the transition status.

25. The article of claim 22, further comprising instructions that if executed enable the system to store one or more properties of a queue.

26. The article of claim 25, further comprising instructions that if executed enable the system to store at least one property of said active queue and to dequeue one or more packets from said active queue based on said at least one property.
